(19) United States
(12) Patent Application Publication
(10) Pub. No.: US 2008/0076095 A1
(43) Pub. Date: Mar. 27, 2008

(54) Method Of Calligraphy Hand-Writing And Drawing Teaching, Kit For Hand-Writing And Drawing Teaching

(76) Inventors: Aurelius Glicksteins, Riga (LV); Mihail Glicksteins, Riga (LV); Grigori Brudoli, Bat Yam (IL)

Correspondence Address: CARELLA,BYRNE,BAIN, GILFILLAN, CECCHI, STEWART &;OLSTEIN, 5 BECKER FARM ROAD, ROSELAND, NJ, 07068-1739, US

(21) Appl. No.: 11/792,884

(22) PCT Filed: Dec. 9, 2005
(86) PCT No.: PCT/IB05/04046

§ 371 Date: Jun. 11, 2007

(30) Foreign Application Priority Data
Dec. 14, 2004 (EA) 200401486

(51) Int. Cl. G09B 11/00; B65D 69/00; G09B 11/04

(52) U.S. Cl. 434/87; 206/579; 434/162; 434/163

(57) ABSTRACT

The invention belongs to calligraphy hand-writing and drawing teaching field, and can be used for improvement of hand motility mastering, and at the same time it is directed at training of counting, hand-writing, drawing skills and other creative abilities development. The problem solved by the invention is in creation of method and complete set for calligraphy hand-writing and drawing teaching that is free from indicated imperfections and at the same time permit to develop spatial reasoning, imagination, hand motility and creative abilities. The problem is solved by the fact that, according to the invention, draw graphic element, figure or letter are written by a stencil, at first lines are transferred from a stencil to a paper, then a stencil is moved against a paper, then stencil lines are placed against lines obtained on a paper, and lines are again transferred from a stencil to a paper and after creating required composition or pattern on a paper the obtained drawing is colored. The problem is solved as well by the fact that the teaching kit is supplied with self copying paper and stencil with the lines of composition parts. There are another differences from prototype. The invention allow creative of method and complete set for calligraphy hand writing and drawing teaching that is free from indicated imperfections and at the same time permit to develop spatial reasoning, imagination, hand motility and creative abilities.

### TECHNICAL FIELD

The invention belongs to calligraphy hand-writing and drawing teaching field, and can be used for improvement of hand motility mastering, and at the same time it is directed at training of counting, hand-writing, drawing skills and other creative abilities development.

### BACKGROUND ART

The methods of pupils teaching of fine arts activity are known including the methods when pupils carry out exercises of graphical or pictorial fixation of definite theme object given to the pupils by a teacher on the material support or base and pupils stimulation by a teacher according to the results of fine arts activity [1, 2, 3].

The known methods don't allow to increase fine arts teaching effectiveness, e.g. in group or collective of traditional not specialized schools, as the method of teaching comes to passive participation, mechanical execution of exercises on the offered demonstrated by teacher themes. During lessons the main part of pupils repeats and copies single object pieces, therefore the development and perfecting of the inherited intrinsic inclinations in each pupil in a group can't be achieved. It can be explained by separation of pupil's creative component from an active work component during fine arts activity.

Another method of the pupils fine arts teaching is known too [4], including performance by the pupils of exercises on the material support, graphical or pictorial fixation of an object, and an teaching is realized in several stages with rendering appropriate information block of multidimensional space to the pupils at each stage before exercises performance and object fixation such as multidimensional space of the images, connected with executed activity or process situation, at that for elementary teaching the information block includes the images of letters, flora and fauna, a man with physical elements arranged in one or two plans; at the next stage the information block includes the figures and different objects images of personages and compositions; and at the subsequent and final stages the information blocks depicts theme objects, connected with subject themes according to the class of teaching; graphical or pictorial fixation of definite theme object on the material support carries out by pupils at simultaneous establishment of 1-st degree feed-back communication between the teacher and pupils; posters, slides, videotape recording and other artwork with text support are used as information blocks.

The weak point of this method is the complex methodological basis, and moreover it cannot be realized at domestic level, during child self-dependent work or work under adult's supervision. The other disadvantage of the known method is in the fact that it is difficult to use it for small children, when the dactyl coordination is insufficiently developed, and notion of proportionality and sense of three-dimensional subject's arrangement are absent.

The method of calligraphic handwriting and handwriting correction teaching is known too, according to that one graphic element or letter are written without separation, under metronome strokes, that are gradually accelerated and at that time stencil made of direct lines and slanting lines with an angle of 60-85 degrees is used [5].

The weak point of this method is restricted stencil opportunities, which practicably allows correcting only writing of inclined and horizontal elements at constantly accelerated rate.

The coloring book with back and front covers is known at that the front cover is supplied with opening element, a series of color illustrations on the front cover and pages with uncolored illustrations matching with illustrations put on the front cover [6].

The known complete set for coloring does not allow to develop the creative potential in pupil, as it doesn't intended for self-dependent drawing pupil work and doesn't give him creativity freedom for preparation of own drawings.

The method and work stock for creating decorative compositions intended for development of initial skills of material color features usage are known when work stocks with grooves showing contours of objects intended for coloring are used [7]. At first the known method provides running a paintbrush on a groove and then removal of excessive paint outside grooves. This invention allows receiving beautiful and straight line, that positively influences on pupil desire to train and to receive good results from an initial level.

The imperfection of the known method and work stock is the limitation of method potentialities, as it is necessary to prepare special work stocks for each and, therefore, trainee has no opportunity of creating his own drawings.

The problem solved by the invention is in creation of method and complete set for calligraphy hand-writing and drawing teaching that is free from indicated imperfections and at the same time permit to develop spatial reasoning, imagination, hand motility and creative abilities.

### DISCLOSURE OF INVENTION

The problem is solved by the fact that, according to the invention, in the known method of calligraphy hand-writing and drawing teaching, when graphic element, figure or letter are written by a stencil, at first lines are transferred from a stencil to a paper, then a stencil is moved against a paper, then stencil lines are placed against lines obtained on a paper, and lines are again transferred from a stencil to a paper and after creating required composition or pattern on a paper the obtained drawing is colored.

The problem is solved as well by the fact, that after creating the first composition with the help of a stencil the pupils begin to draw the second composition without a stencil.

The problem is solved as well by the fact, that the second and the subsequent compositions are being drawn in reduced or extended scale.

The problem is solved as well by the fact that the known teaching kit for calligraphy hand-writing and drawing including stencil with marked lines and paper, according to the invention, is supplied with self copying paper and stencil with the lines of composition parts.

The problem is solved as well by the fact that a stencil is made of transparent or partially transparent material ensuring stress transfer from the transferring instrument to a paper and that set package includes in addition the patterns of compositions made in color.

The problem is solved as well by the fact that the lines made on stencil are marked on compositions patterns.

The problem is solved as well by the fact that a frame or a mat for finished composition arrangement is additionally included in set, which encourages the pupil by causing him to treat his outcome as a real picture.

The problem is solved as well by the fact that patterns of compositions are made as computer files in enclosed to the kit or supplied separately on digital memory, for example, diskette or optical disk.

The problem is solved as well by the fact that a self copying paper is made on self-adhesive base.

The problem is solved as well by the fact that a self copying paper is made on magnetic base.

The problem is solved as well by the fact that the stencil lines are made in dash lines in the form of dashes or dots.

The problem is solved as well by the fact that a paper is made of transparent or partially transparent and put over a stencil.

The problem is solved as well by the fact that at least one book is additionally included in set and a stencil has picture of characters or topics this book.

The problem is solved as well by the fact that a stencil or mat is additionally included in set and background of frame has a color or background picture.

### BRIEF DESCRIPTION OF DRAWINGS

The invention is illustrated by figures.

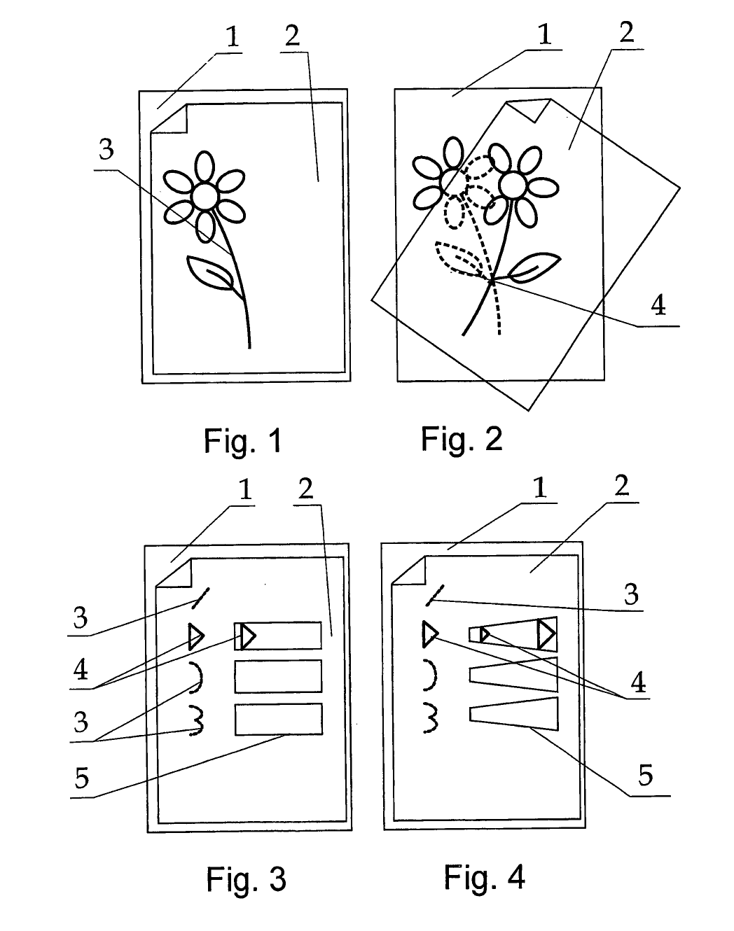

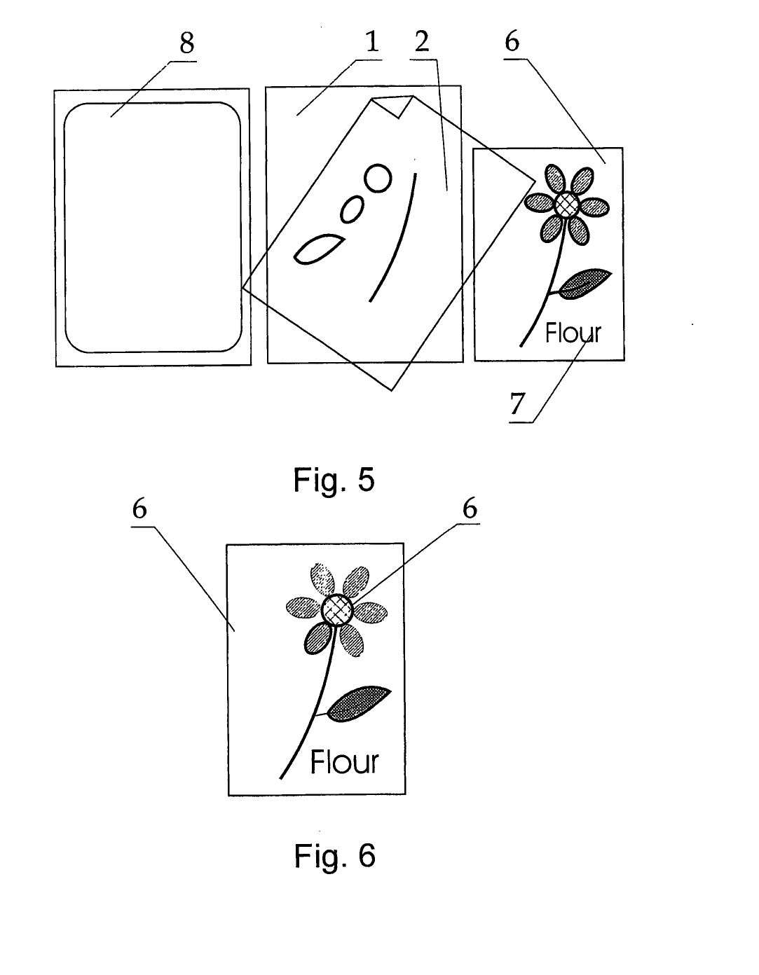

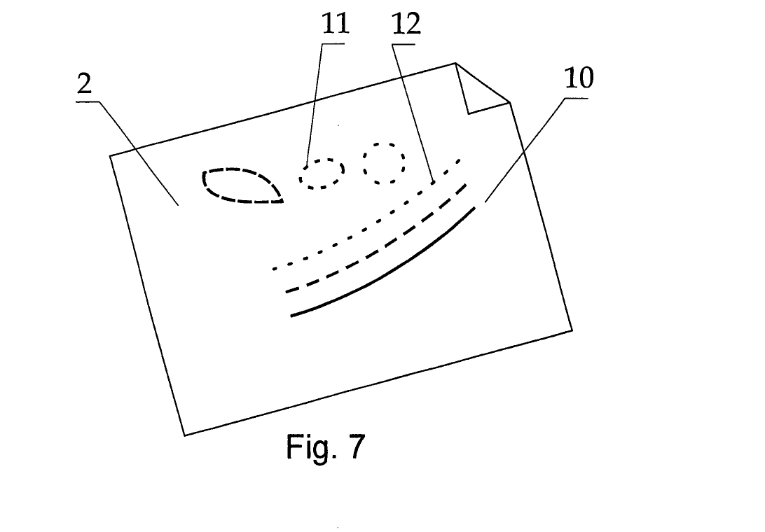

The scheme of method of calligraphy hand-writing and drawing teaching according to the invention is depicted in FIG. 1 and FIG. 2. The method modernization, connected with teaching of the second composition drawing without a stencil is shown in FIG. 3 and FIG. 4. One of teaching set variants for calligraphy hand-writing and drawing is given in FIG. 5. The variant of composition pattern with stencil emphasized lines is depicted in FIG. 6. The examples of stencil lines made in solid or dash lines in the form of dashes or dots are shown in FIG. 7.

### BEST MODE FOR CARRYING OUT THE INVENTION

The method is realized in the following way. The stencil 2 is placed on a paper sheet. The elements of composition 3 are made beforehand on stencil 2, which can be done in a form of lines, patterns, pattern elements. After transferring from stencil 2 to sheet 1 by known methods of composition element 3, a copied element 4 of pattern 3 remains on a paper. Stencil 2 is moved and turned to arrange a new pattern or composition element on plotted drawing 4. One of elements 3 is transferred again on paper 1 and further this action is repeated till complete composition making-up. Composition is colored after it's finishing with the help of known methods and means, for example, by soft-tip pens, paints (that is not shown).

The windows 5 are made in stencil 2 in one of invention variants, which can be rectangular (FIG. 3) or trapezoidal (FIG. 4).

For realization of claimed method the kit includes paper 1, one or several different stencils 2 with the marked elements of composition or pattern and pattern 6 of composition. The pattern 6 can be colored and have explicated inscriptions and/or FIG. 7. Several patterns 7 can be put in complete set (not shown). Moreover the patterns can be enclosed as computer files on known digital carriers (not shown), at that they could be printed out immediately in place. It allows to supply sets with a great number of pattern collections 1 and subsequently to supply the consumers by e-mail and Internet. The kit can be provided with housing 8 or other frame for ready composition placement.

For promotion of set teaching characteristics those composition 9 elements can be marked out, which are made on stencil 2.

The lines on stencil 2 can be executed by the way of solid lines 10, or in dash lines, e.g. in the form of dashes 11 or dots 12.

The work with complete set is in the following. With the help of the teacher a pupil plans a composition theme and selects a stencil from The. self copying paper can be used as a paper. Polyethylene polyester film, tracing paper or similar materials can be used as stencil 2. Pattern 3 lines, representing compositions parts are drawn on it by the known methods.

The pupil finds proper elements in the stencil and transfers them on a self copying paper. In the present description the self copying paper is a paper, on which the trace is resulted after instrument draw through a layer of other material and without dye-stuffs transfer from the instrument. Everything that results in good imprint can be used as an instrument: stylus, pencil or ball-point pen. Self copying paper usage allows applying transparent and rather mild stencils without holes cutting-out, that is much more manufacturability during production. Besides such paper use allows applying any pointed article. Then pupil transfers the stencil and turns it to arrange stencil lines in such a way to take into account the positions of the copied lines and then draws the new lines. So he continues to copy lines, creating the necessary composition. After finishing composition drawing, the pupil colors it.

During calligraphic hand-writing teaching, at first the pupil transfers elements of figures and letters from the stencil, arranging the marks as a whole, then draws some figures in the cut-out stencil field 6 without stencil and compares them with figures drawn with the help of stencil. The height of symbols is limited by the width of a cut 6 in the stencil, forcing the pupil to draw figures of one dimension. Later on it is possible to offer to the pupil to draw symbols proportionally miniaturized or enlarged, with the help of trapezoidal holes in stencils, thus developing proportionality sense at drawing symbols. The drawing of lines 3 on the stencil by solid 10 or dash lines 11, 12 allows to develop smooth motion skill and to develop hand motility in pupil.

After composition finishing and its coloring, the pupil can put it in housing 8 or other frame for a storage and exposition. If as a self copying paper and self-adhesive is used as a paper, then it is easily possible to stick pupil's work in an album or other place. If a magnetized paper is used, it is possible to use works as decoration, attached to such metal articles as refrigerators, cabinets, etc.

### INDUSTRIAL APPLICABILITY

The positive effect of the invention use is in universality of the method and kit, in potentialities of its application for drawing teaching for development of spatial reasoning, imagination, hand motility and creative abilities.

One of the variants of the invention is realized when the paper is transparent or partially transparent, hence the paper is on the stencil 2 place, and the stencil is on the paper 1 place. In this case, the pupil transfers lines on transparent paper or partially transparent paper, drawing on the stencil, after removing paper, drawing again getting ready composition. At the finish, the pupil places this ready composition in the frame, and color background frame or background picture is showing through transparent or partially transparent papers. The frame could have been printed on the cover. This set may be accompanied with book, after reading this book, the pupil get task to draw one of the themes or characters.

The present invention is preparing for production and sale.

Information Sources Taken into Consideration at Expert Examination
1. V. C. Kusin “Fine arts and methodology of its teaching at school. Moscow, “Agar”, 1998, pp. 54, 59, 103.
2. The procedure of drawing teaching in 8-years school. Ped. Sciences Academy of RSFSR, Moscow 1963, under Fomichev edition, pp. 78, 79, 100-103.
3. The procedure of fine arts teaching at school. N. N. Rostovtseva, “Randevu-AM”, pp. 185-192, 118-121.
4. Patent of Russian Federation No 2239235. Int. Cl. G09B 11/10, issue Oct. 27, 2004.
5. Patent of Russian Federation No 2206128. Int. Cl. G09B 11/00, issue of Oct. 11, 2002.
6. Patent of U.S. Pat. No. 1,698,739, Int. Cl. G09B 11/10, issue Jan. 15, 1929.
7. Patent of U.S. Pat. No. 6,786,728, Int. Cl. G09B 11/10, issue Jul. 9, 2004.

1. A method of calligraphy hand-writing and drawing teaching, according to which a graphic element, figure or letter are written with the help of a stencil that is characterized in that at first lines are transferred from a stencil to a paper, then a stencil is moved against a paper, then stencil lines are placed against lines obtained on a paper, and lines are again transferred from a stencil to a paper and after creating required composition or pattern on a paper the obtained drawing is colored.

2. A method according to item 1 is characterized in that after creating the first composition with the help of a stencil the pupils begin to draw the second composition without a stencil

3. A method according to item 2 is characterized in that the second and the subsequent compositions are drawing in reduced or extended scale.

4. The teaching kit package for calligraphy hand-writing and drawing including stencil with marked lines and paper is characterized in that it is supplied with self copying paper and stencil with the lines of composition parts.

5. The kit according to item 4 is characterized in that a stencil is made of transparent or partially transparent material ensuring stress transfer from the transferring instrument to a paper and that set package includes in addition the patterns of compositions made in color.

6. The kit according to item 4 is characterized in that the lines made on stencil are marked on compositions patterns.

7. The kit according to any of items 4-6 is characterized in that a frame or a mat for finished composition arrangement is additionally included in set.

8. The kit according to item 4 is characterized in that the patterns of compositions are made as computer files in enclosed to The or supplied separately digital carrier, for example, diskette or optical disk.

9. The kit according to item 4 is characterized in that a self copying paper is made on self-gumming base

10. The kit according to item 4 is characterized in that a self copying paper is made on magnetic base.

11. The kit according to any of items 6-8 is characterized in that the stencil lines are made in dash lines in the form of dashes or dots.

12. The teaching kit package for calligraphy hand-writing and drawing including stencil with marked lines and paper is characterized in that a paper is made transparent or partially-transparent and put over a stencil.

13. The kit according to any of items 4 or 12 is characterized in that at least one book is additionally included in set and a stencil has picture of characters or topics of this book.

14. The kit according to any of items 6-8 is characterized in that a stencil or mat is additionally included in set and background of frame has a color or background picture.
